(19) United States
(12) Patent Application Publication
(10) Pub. No.: US 2026/0066972 A1
(43) Pub. Date: Mar. 5, 2026

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Xiaoying MA, Shenzhen (CN); Mengzhu CHEN, Shenzhen (CN); Hong TANG, Shenzhen (CN); Jun XU, Shenzhen (CN); Xuan MA, Shenzhen (CN); Qiujin GUO, Shenzhen (CN)

(73) Assignee: ZTE CORPORATION, Shenzhen (CN)

(21) Appl. No.: 19/385,074

(22) Filed: Nov. 10, 2025

Related U.S. Application Data
(63) Continuation of application No. PCT/CN2023/093913, filed on May 12, 2023.

(51) Int. Cl. H04B 7/06; H04W 72/11

(52) U.S. Cl. CPC H04B 7/0626; H04W 72/11

(57) ABSTRACT

A wireless communication method is disclosed. The method comprises receiving, by a wireless communication terminal from a wireless communication node, at least one channel state information, CSI, report configuration associated with a channel state information reference signal, CSI-RS, resource setting for a channel measurement, wherein the CSI-RS resource setting comprises one or more CSI-RS resources associated with one or more adaptation patterns; and performing, by the wireless communication terminal, a CSI reporting according to the at least one CSI report configuration.

### CROSS-REFERENCE TO RELATED PATENT APPLICATIONS

This application is a continuation of International Patent Application No. PCT/CN2023/093913, filed May 12, 2023, which is incorporated herein by reference in its entirety.

### TECHNICAL FIELD

This document is directed generally to wireless communications, and in particular to 5th generation (5G) communications or 6th generation (6G) communications.

### BACKGROUND

The CSI (Channel State Information) plays a crucial role in 5G communication. It refers to the knowledge or information about the wireless channel conditions between a user device and the base station. The CSI provides valuable insights into factors such as signal quality, interference levels, and available resources.

### SUMMARY

In 5G communication systems, The CSI is utilized to optimize various aspects of network performance. It helps determine the best transmission parameters, such as modulation and coding schemes, beamforming, and resource allocation, to enhance data rates and overall system efficiency. By continuously monitoring and updating the CSI, 5G networks can dynamically adapt and optimize their operations based on real-time channel conditions, leading to improved network capacity, reliability, and user experience. The configurations and adoptions of the CSI are still a topic to be discussed.

This document relates to methods, systems, and computer program products for a wireless communication.

One aspect of the present disclosure relates to a wireless communication method. In an embodiment, the wireless communication method includes: receiving, by a wireless communication terminal from a wireless communication node, at least one channel state information, CSI, report configuration associated with a channel state information reference signal, CSI-RS, resource setting for a channel measurement, wherein the CSI-RS resource setting comprises one or more CSI-RS resources associated with one or more adaptation patterns; and performing, by the wireless communication terminal, a CSI reporting according to the at least one CSI report configuration.

Another aspect of the present disclosure relates to a wireless communication method. In an embodiment, the wireless communication method includes: transmitting, by a wireless communication node to a wireless communication terminal, at least one channel state information, CSI, report configuration associated with a channel state information reference signal, CSI-RS, resource settings for a channel measurement to allow the wireless communication terminal to perform a CSI reporting according to the at least one CSI report configuration, wherein the CSI-RS resource setting comprises one or more CSI-RS resources associated with one or more adaptation patterns.

Another aspect of the present disclosure relates to a wireless communication terminal. In an embodiment, the wireless communication terminal includes a communication unit and a processor. The processor is configured to: receive, via the communication unit from a wireless communication node, at least one channel state information, CSI, report configuration associated with a channel state information reference signal, CSI-RS, resource setting for a channel measurement, wherein the CSI-RS resource setting comprises one or more CSI-RS resources associated with one or more adaptation patterns; and perform a CSI reporting according to the at least one CSI report configuration.

Another aspect of the present disclosure relates to a wireless communication node. In an embodiment, the wireless communication node includes a communication unit and a processor. The processor is configured to: transmit, via the communication unit to a wireless communication terminal, at least one channel state information, CSI, report configuration associated with a channel state information reference signal, CSI-RS, resource settings for a channel measurement to allow the wireless communication terminal to perform a CSI reporting according to the at least one CSI report configuration, wherein the CSI-RS resource setting comprises one or more CSI-RS resources associated with one or more adaptation patterns.

Various embodiments may preferably implement the following features:

Preferably or in some embodiments, the wireless communication terminal reports to the wireless communication node CSIs without overhead reduction in response to a first condition being satisfied, and the first condition comprises at least one of:
a CSI report configuration corresponding to the CSIs indicating that the CSI reporting is aperiodic;
a CSI report configuration corresponding to the CSIs being activated or triggered by Downlink Control Information, DCI;
the wireless communication terminal being configured with a Radio Resource Control, RRC, signaling indicating reporting the CSIs without overhead reduction;
a CSI report configuration corresponding to the CSIs comprising more than one set of codebook configuration parameters;
the wireless communication terminal not receiving an indication indicating a baseline adaptation pattern;
the wireless communication terminal receiving an indication indicating reporting the CSIs without overhead reduction;
the CSI report is transmitted in physical uplink shared channel;
the number of CSIs in the CSI report is less than a threshold;
the number of adaptation patterns associated with the corresponding CSI report configuration is less than a threshold; or
a number of CSI processing units of the wireless communication terminal being greater than or equal to a threshold.

Preferably or in some embodiments, the wireless communication terminal reports to the wireless communication node CSIs with overhead reduction in response to a second condition being satisfied, and the second condition comprises at least one of:
the wireless communication terminal receiving an indication indicating reporting the CSIs with overhead reduction;
the wireless communication terminal being configured with an RRC signaling indicating reporting the CSIs with overhead reduction;
the wireless communication terminal receiving an indication indicating a baseline adaptation pattern;
a number of the CSIs being equal to a number of adaptation patterns associated with a corresponding CSI report configuration;
a CSI report configuration corresponding to the CSIs being associated with a first resource setting;
the CSI report is transmitted in physical uplink control channel;
the number of CSIs in the CSI report is larger than or equal to a threshold;
the number of adaptation patterns associated with the corresponding CSI report configuration is larger than or equal to a threshold; or
a CSI report configuration corresponding to the CSIs comprising at least one of: one or more port subset indications, only one set of codebook configuration parameters, or more than one CSI report quantity.

Preferably or in some embodiments, the first resource setting comprises at least one of:
a resource set comprising only one resource; or
a plurality of resources, each resource being configured with a group index or a adaptation pattern.

Preferably or in some embodiments, the wireless communication terminal reports CSIs without overhead reduction every M CSI report occasions, and M is an integer greater than one.

Preferably or in some embodiments, a CSI report configuration comprises L sub-configurations associated with K uplink resource configurations, L and K are integers, each uplink resource configuration correspond to one or more of the L sub-configurations, and one or more CSIs corresponding to one or more sub-configurations among the L sub-configurations associated with a corresponding uplink resource configuration are reported according to the corresponding uplink resource configuration.

Preferably or in some embodiments, one or more first CSIs based on a corresponding one or more sub-configurations of the L sub-configurations are reported without overhead reduction via a corresponding first uplink resource configuration.

Preferably or in some embodiments, the first uplink resource configuration is the first uplink resource configuration configured in the CSI report configuration or the uplink resource configuration with a lowest index in a CSI report configuration.

Preferably or in some embodiments, each uplink resource configuration is at least one of:
a configuration semiPersistentOnPUSCH;
a configuration semiPersistentOnPUCCH;
a configuration periodic;
a configuration reportSlotConfig; or
a configuration pucch-CSI-ResourceList.

Preferably or in some embodiments, the wireless communication terminal receives an indication for activating a CSI-RS resource set in the CSI-RS resource setting, a part of adaptation pattern s associated with a CSI report configuration corresponding to the CSI-RS resource set, or a part of adaptation patterns associated with the CSI-RS resource set.

Preferably or in some embodiments, the wireless communication terminal receives an indication activating a CSI report configuration and a part of sub-configurations among all sub-configurations or a part of adaptation patterns among all adaptation patterns associated with the CSI report configuration to be activated.

Preferably or in some embodiments, after the wireless communication terminal receives a first signaling with a first field indicating a first trigger state for activating a CSI report configuration and a second field activating a first part of sub-configurations among all sub-configurations or a first part of adaptation patterns among all adaptation patterns associated with the CSI report configuration to be activated, the wireless communication terminal is able to receive a second signaling with a first field indicating a second trigger state for activating the CSI report configuration and a second field activating a second part of sub-configurations among all sub-configurations or a second part of adaptation patterns among all adaptation patterns associated with the CSI report configuration to be activated, wherein the first part of sub-configurations and the second part of sub-configurations are different, or the first part of adaptation patterns and the second part of adaptation patterns are different.

Preferably or in some embodiments, after the wireless communication terminal receives an indication of a first signaling for activating a CSI report configuration and activating a first part of sub-configurations among all sub-configurations or a first part of adaptation patterns among all adaptation patterns associated with the CSI report configuration to be activated, the wireless communication terminal is able to receive an indication of a second signaling for activating the CSI report configuration and activating a second part of sub-configurations among all sub-configurations or a second part of adaptation patterns among all adaptation patterns associated with the CSI report configuration to be activated, wherein the first trigger state indicated in a field of first signaling indicates the CSI report configuration to be activated and the first part of the sub-configurations or the first part of adaptation patterns, the second trigger state indicated in a field of second signaling indicates the CSI report configuration to be activated and the second part of the sub-configurations or the second part of adaptation patterns, and the first part of sub-configurations and the second part of sub-configurations are different, or the first part of adaptation patterns and the second part of adaptation patterns are different.

Preferably or in some embodiments, the first signaling or second signaling is a Downlink Control Information, DCI, or a Medium Access Control Control Element, MAC CE, a bitmap is used to activate a part of sub-configurations among all sub-configurations or a part of adaptation patterns among all adaptation patterns associated with the CSI report configuration to be activated, each bit in the bitmap is associated with one or more sub-configurations or one or more adaptation patterns, a first value of a bit indicates one or more corresponding sub-configurations or one or more corresponding adaptation patterns are not activated or deactivated, and a second value different from the first value of a bit indicates one or more corresponding sub-configurations or one or more corresponding adaptation patterns are activated.

Preferably or in some embodiments, the wireless communication terminal reports CSIs with overhead reduction includes at least a differential RI, wherein the differential RI indicates an offset value between a first RI value and a second RI value and is indicated in a 1-bit field, and one state of the 1-bit field means the offset value is 0 and the another state of the 1-bit field means the offset value is −1.

Preferably or in some embodiments, the wireless communication terminal reports CSIs with overhead reduction includes at least a worst layer indication, WLI, and the WLI indicates which column of a precoder matrix of a common PMI corresponds to a weakest layer of a codeword.

Preferably or in some embodiments, the wireless communication node transmits an indication for activating a CSI-RS resource set in the CSI-RS resource setting, a part of adaptation patterns associated with a CSI report configuration corresponding to the CSI-RS resource set, or a part of adaptation patterns associated with the CSI-RS resource set.

Preferably or in some embodiments, the wireless communication node transmits an indication activating a CSI report configuration and a part of sub-configurations among all sub-configurations or a part of adaptation patterns among all adaptation patterns associated with the CSI report configuration to be activated.

Preferably or in some embodiments, the wireless communication node receives a CSIs with overhead reduction, the CSIs with overhead reduction includes at least a differential RI, wherein the differential RI indicates an offset value between a first RI and a second RI and is indicated in a 1-bit field, and one state of the 1-bit field means the offset value is 0 and the another state of the 1-bit field means the offset value is −1.

Preferably or in some embodiments, the wireless communication node receives CSIs with overhead reduction, the CSIs with overhead reduction includes at least a worst layer indication, WLI, and the WLI indicates which column of a precoder matrix of a common PMI corresponds to a weakest layer of a codeword.

The present disclosure also relates to a computer program product comprising a computer-readable program medium code stored thereupon, the code, when executed by a processor, causing the processor to implement a wireless communication method recited in any one of foregoing methods.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a wireless communication method according to an embodiment of the present disclosure.

FIG. 2 shows an example of a wireless communication method according to an embodiment of the present disclosure.

FIG. 3 shows an example of a wireless communication method according to an embodiment of the present disclosure.

FIG. 4 shows an example of a schematic diagram of a wireless communication terminal according to an embodiment of the present disclosure.

FIG. 5 shows an example of a schematic diagram of a wireless communication node according to an embodiment of the present disclosure.

FIGS. 6 and 7 show flowcharts of wireless communication methods according to some embodiments of the present disclosure.

### DETAILED DESCRIPTION

In some embodiments, large bandwidth multi-antennas are used in 5G communication systems, which result in significant power consumption due to the large number of spatial elements.

In some embodiments, to reduce the power consumption of the gNB (gNodeB), one potential method is reducing the number of antennas or antenna ports. The channel may be also changes if the number of antennas changed. To help the gNB obtain the channel states of different numbers of antennas, multiple CSIs with different adaptation patterns are needed. The multiple CSIs with different adaptation patterns may be obtained by a specific CSI report configuration type.

However, the overhead may be large if the User Equipment (UE) always needs to report multiple CSI reports. To reduce the UL signaling overhead, some embodiments of the present disclosure described below may be used.

In some embodiments, the User Equipment (UE) can be configured with one or more CSI (channel state information) report configurations. Each CSI report configuration is configured by the CSI-ReportConfig signaling. The CSI-ReportConfig may associate with one CSI-RS resource setting by the CSI-resourceConfigID for the channel measurement. The CSI-RS resource setting is configured by the CSI-ResourceConfig signaling.

The number of ports of a CSI-RS is configured by nrofPorts (e.g., indicates number of ports) in the CSI-ResourceMapping, and the CSI-ResourceMapping is associated with an NZP-CSI-RS-Resource. The NZP-CSI-RS-Resource is associated with an NZP-CSI-RS-ResourceSet. An NZP-CSI-RS-ResourceSet is associated with a CSI-ResourceConfig. A CSI-ResourceConfig is associated with a CSI-ReportConfig. The nrofPorts can be one of the following: p1, p2, p4, p8, p12, p16, p24, or p32, p1 indicates that the number of ports is 1, p2 indicates that the number of ports is 2, and so on.

In an embodiment, there is provided a method of receiving, on the UE side, RRC (Radio Resource Control) signaling, the RRC signaling includes one or more CSI report configurations, the CSI report configurations is associated with a CSI-RS resource setting, wherein the CSI-RS resource setting includes one or more CSI-RS resource associated with more than one adaptation pattern (also referred to as spatial pattern in the present disclosure). The method also includes performing CSI report according to the CSI report configurations.

In some embodiments, the adaptation patterns include at least one of the following: number of ports, port indices indication, group indication, power offset, an index (e.g., a CRI (CSI-RS Resource Indicator), a resource set ID, a resource setting ID), TCI (transmission configuration indicator), CDM (code division multiplexing), resource mapping, CDM group index, frequency domain resource, time domain resource, sub-configuration, a group index. In the present disclosure, the phrase that the adaptation pattern is different means one or more of the adaptation patterns are different.

In some embodiments, power offset corresponds to the powerControlOffset or the powerControlOffsetSS and number of ports means number of CSI-RS ports.

In some embodiments, the powerControlOffset is the assumed ratio of PDSCH (physical downlink shared channel) EPRE (Energy Per Resource Element) to NZP (non-zero-power) CSI-RS EPRE when the UE derives CSI feedback. powerControlOffset takes values in the range of [−8, 15] dB with 1 dB step size.

In some embodiments, the powerControlOffsetSS is the assumed ratio of NZP (Non-zero power) CSI-RS EPRE to SS/PBCH block EPRE (Energy per resource element)).

In some embodiments, a CSI report configuration corresponds to a CSI-ReportConfig configured by RRC signaling.

In some embodiments, a sub-configuration includes at least one of the following: a port subset indication, a set of codebook configuration parameters, a group identity, a group ID, a power offset, a resource indication, a report quantity, an index, and/or a reportFreqConfiguration.

In some embodiments, each sub-configuration is associated with an adaptation pattern.

In an embodiment, the CSI report configuration is associated with L adaptation patterns. The UE reports N CSIs in one reporting occasion for the CSI report configuration, where 1<=N<=L. N and L are integers less than 7. N CSIs are generated or calculated according to N adaptation patterns among the L adaptation patterns.

In some cases, N CSIs are reported without overhead reduction, In some other cases, N CSIs are reported with overhead reduction.

In some embodiments, the CSI report without overhead reduction is a first CSI report mode.

In some embodiments, the CSI report with overhead reduction is a second CSI report mode.

In some embodiments, the CSI report configuration is associated with L adaptation patterns means that L sub-configurations are configured in a CSI report configuration. In some embodiments, the CSI report configuration is associated with L adaptation patterns means that L adaptation patterns are configured in a CSI-RS resource setting which associates with the CSI report configuration.

In some embodiments, the reporting of the N CSIs without overhead reduction means that all the CSI quantities for each spatial pattern are reported independently. For example, if CSI quantities for each spatial pattern include CRI (CSI-RS resource indicator), RI (Rank Indicator), PMI (Precoding Matrix Indicator), CQI (Channel Quality Indicator), then, the UE reporting N CSIs means that the UE reports N sets of CRI, RI, PMI, and/or CQI, where each set of CRI, RI, PMI, and/or CQI are associated with an adaptation pattern.

In some embodiments, the reporting of the N CSIs with overhead reduction means that solutions to compress the CSI overhead are used, e.g., a common CRI, RI, PMI, CQI, and/or L1-RSRP (reference signal received power), or a differential/threshold-based RI, CQI, and/or L1-RSRP, or a joint coded RI are used. For example, if the CSI quantities for each adaptation pattern include a CRI, RI, PMI, CQI, then, the UE reports one common CRI, one common PMI, and one RI, one CQI, (N−1) differential RIs, (N−1) different CQIs. In such a configuration, the signaling overhead is reduced.

In some embodiments, the processing for reporting N CSIs with overhead reduction and processing for reporting N CSIs without overhead reduction are different. The UE and the gNB need to know when the UE reports N CSIs with overhead reduction and when the UE reports N CSIs without overhead reduction.

In some embodiments, the determination of CSI report mode (for example, determination between CSI report with overhead reduction and CSI report without overhead reduction, or determination between the first CSI report mode and the second CSI report mode) depends on at least one of the following factors:
The CSI report type. For example, the CSI report type includes aperiodic CSI report, semi-persistent CSI report, or periodic CSI report.
The CSI report activation and/or triggering signaling.
The number of the sets of one or more codebook configuration parameters.
An information in an indication signaling which determines the CSI report mode. In some embodiments, the indication is at least one of a downlink control information, a MAC CE, a RRC signaling.
The value of N and/or L.
The number of occupied or unoccupied CPU (CSI processing units).
The CSI report configuration.
UE capability.
Codebook type. For example, Codebook type includes type 1 codebook or type 2 codebook.
TRP type. For example, Codebook type includes single TRP type or multi-TRP type.
The channel type that the CSI report is transmitted. For example, the channel type includes physical uplink shared channel or physical uplink control channel.

In some embodiments, if a first condition satisfied, the UE reports N CSIs without overhead reduction.

In some embodiments, the first condition includes at least one of the following:
The CSI report configuration of the N CSIs is an aperiodic CSI report;
The CSI report configuration is activated and/or triggered by a DCI (Downlink Control Information);
The CSI report configuration is configured with more than one set of codebook configuration parameters;
Receiving a DCI or a MAC CE (Medium Access Control Control Element) indicates reporting CSI without overhead reduction;
UE does not support reporting CSI with overhead reduction; Receiving a RRC indicating reporting CSI without overhead reduction;
N=1;
The CSI report configuration is associated with a specific resource setting;
The CSI report configuration includes a specific configuration; and/or
The number of unoccupied CPUs (CSI processing units) greater than or equal to a second threshold, in which at least one of the following applies:
   The second threshold is predefined value or is the number of CPUs occupied by the N CSIs without overhead reduction. In some embodiments, if a UE supports N_CPU simultaneous CSI calculations, the UE has N_CPU CSI processing units for processing CSI reports. If L CPUs are occupied for calculation of CSI reports in a given OFDM symbol, the UE has N_CPU-L unoccupied CPUs;
   The second threshold is configured by RRC signaling; and/or
   The second threshold is associated with UE capability.

In some embodiments, if a first condition is not satisfied, the UE reports N CSIs with overhead reduction.

In some embodiments, if a second condition satisfied, the UE reports N CSIs with overhead reduction.

In some embodiments, the second condition includes at least one of the following:
N is greater than 1;
N is greater than a threshold, the threshold is an integer greater than 1 and less than or equal to L, in which in some embodiments, the threshold is predefined or configured by higher layer signaling;
Receiving a DCI or MAC CE indicates reporting CSI with overhead reduction;
Receiving a RRC indicates reporting CSI with overhead reduction;
N=L;
The CSI report configuration is associated with a specific resource setting, in which the specific resource setting includes at least one of the following:
   A resource setting includes a resource set, the resource set includes only one resource;
   A resource setting includes a resource set, the resource set includes resources configured with same number of ports;
   All resources in the resource setting configured with same number of ports;
   A resource setting includes resources, each resource configured with a group index or an adaptation pattern;
   A resource setting includes more than one resource sets, each resource set associated with an adaptation pattern;
   A resource setting includes resources configured with same time and frequency resource;
   A resource setting includes resources with more than one adaptation patterns;
   A resource setting includes resources with more than one adaptation patterns and more than one resources configured with same time and frequency resource;
The CSI report configuration includes a specific configuration, in which the specific configuration includes at least one of the following:
   One or more port subset indications;
   Only one codebookConfig;
   Only one set of codebook configuration parameters;
   Only one CSI report quantity;
   One or more sub-configurations;
   More than one RI restriction;
   More than one codebook subset restriction;
   More than one N1, N2, or Ng, in which N1 and N2 are associated with the number of antenna ports a first and second direction (e.g., a horizontal and vertical direction of an antenna array), and Ng is the number of antenna panels;
   More than one CSI report quantity;
   More than one reportFreqConfiguration; and/or
   More than one codebook types; and/or
The number of unoccupied CPUs is less than a second threshold.

In some embodiments, a set of codebook configuration parameters includes at least one of the following: a codebookconfig, a codebook subset restriction, a RI restriction, a n1,n2, or ng.

In some embodiments, if a second condition is not satisfied, the UE reports N CSIs without overhead reduction.

In some embodiments, the N CSIs without overhead reduction is reported every M reports. For example, for a CSI report configuration, if it is activated or triggered, N CSIs without overhead reduction is reported on first report occasion and reported every M reports occasion, and in other reports occasion, N CSIs with overhead reduction is reported.

In some embodiments, M is predefined or configured by RRC signaling.

In some embodiments, M is associated with UE capability.

In some embodiments, M is indicated by a DCI or a MAC CE.

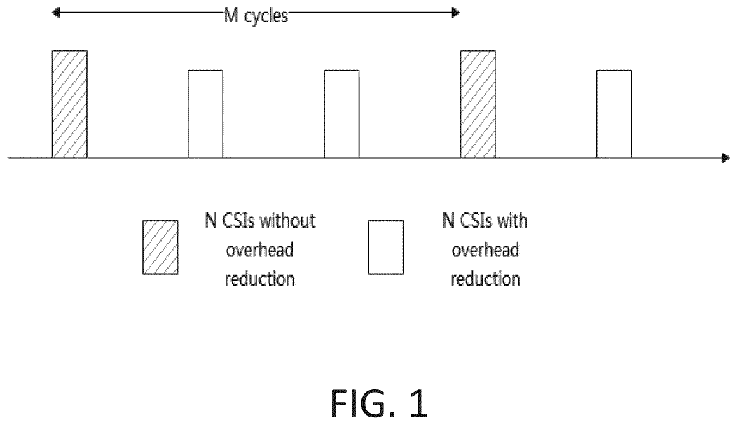

FIG. 1 illustrates an example of N CSIs reporting with and without overhead reduction according to an embodiment of the invention.

In some embodiments, N CSIs with overhead reduction are reported if the UE does not receive an indication indicates to report N CSIs without overhead reduction.

In some embodiments, N CSIs without overhead reduction are reported if first condition is satisfied and the UE does not receive an indication indicating to report N CSIs with/without overhead reduction. If the UE receives an indication indicating to report N CSIs with/without overhead reduction, the UE follows the indication.

In some embodiments, N CSIs with overhead reduction are reported if the second condition is satisfied and the UE does not receive an indication indicating to report N CSIs with/without overhead reduction. If the UE receives an indication indicating to report N CSIs with/without overhead reduction, the UE follows the indication.

In some embodiments, the number of CPUs occupied by the report of N CSIs without overhead reduction and the number of CPUs occupied by the report of N CSIs with overhead reduction are different.

In an embodiment, a CSI report configuration is configured for a semi-persistent CSI report or aperiodic CSI report. For example, semi-persistent CSI report is a CSI report configuration configured with semiPersistentOnPUSCH or semiPersistentOnPUCCH. For example, aperiodic CSI report is a CSI report configuration configured with aperiodic (a high layer parameter). The UE reports N CSIs in one reporting occasion for the CSI report configuration.

In some embodiments, the CSI report configuration configured for a semi-persistent CSI report or aperiodic CSI report is not associated with a periodic CSI-RS resource setting if the UE reports N CSIs in one reporting occasion for the CSI report configuration.

In some embodiments, the CSI report configuration is associated with a semi-persistent CSI resource setting. The UE reports N CSIs in one reporting occasion for the CSI report configuration.

In some embodiments, before a semi-persistent CSI report configuration is activated or triggered, a CSI resource set in the semi-persistent CSI resource setting which is associated with the CSI report configuration is activated or triggered. For example, a MAC CE may be used to activate and/or trigger a CSI resource set.

In some embodiments, the MAC CE indicates and/or activates N adaptation patterns in a resource set.

For example, a resource set includes resources with more than one adaptation pattern, the MAC CE indicates and/or activates N adaptation patterns according to a bitmap. Each bit in the bitmap is associated with a adaptation pattern, one status (e.g., ‘0’) of a bit means the adaptation pattern is not indicated and the other status (e.g., ‘1’) of a bit means the adaptation pattern is indicated.

For another example, the resources in a resource set are divided into different groups, the MAC CE indicates and/or activates N groups. In another example, each resource is associated with a group index.

In some embodiments, the indication may be according to a bitmap. Each bit in the bitmap is associated with a group, one status (e.g., ‘0’) of a bit means the group is not indicated and the other status (e.g., ‘1’) of a bit means the group is indicated.

For example, the MAC CE indicates and/or activates multiple resources. The multiple resources associated with N adaptation patterns. The indication may be according to a bitmap. Each bit in the bitmap is associated with a resource, one status (e.g., ‘0’) of a bit means the resource is not indicated and the other status (e.g., ‘1’) of a bit means the resource is indicated.

For example, the MAC CE indicates and/or activates N or N−1 port subset indication or sub-configurations. The indication may be according to a bitmap. Each bit in the bitmap is associated with a port subset indication or a sub-configuration, one status (e.g., ‘0’) of a bit means the port subset indication or a sub-configuration is not indicated and the other status (e.g., ‘1’) of a bit means the port subset indication or a sub-configuration is indicated.

In some embodiments, the MAC CE indicates the value of N.

In some embodiments, if the UE receives a first MAC CE indicates/triggers a resource set and indicates/trigger a first resources or first adaptation patterns, the UE does not expect to receive a second MAC CE indicating and/or triggering the same resource set and indicates/trigger a second resources or second adaptation patterns before the resource set with a first resources or first adaptation patterns are not de-activated.

In some embodiments, the first resources are associated with different group index with the second resources.

In some embodiments, the first resources are in different groups from the second resources.

In some embodiments, the first resources are associated with different spatial patterns from the second resources.

In some embodiments, after the UE receives a first MAC CE indicating and/or triggering a resource set and indicates/trigger a first resources or first adaptation patterns, if the UE receives a second MAC CE indicating and/or triggering the same resource set and indicates/trigger a second resources or second adaptation patterns, the first resources or first adaptation patterns are de-activated and the second resources or second adaptation patterns are activated (advantageously, the gNB does not need to transmit a signaling to de-activate the first resources).

In some embodiments, after the UE receives a first MAC CE indicating and/or triggering a resource set and indicates/trigger a first resources or first adaptation patterns, if the UE receives a second MAC CE indicating and/or triggering the same resource set and indicates/trigger a second resources or second adaptation patterns, the first resources or first adaptation patterns and the second resources or second adaptation patterns are activated.

In some embodiments, after the UE receives a first MAC CE indicating and/or triggering a resource set and indicating and/or triggering a first resources or first adaptation patterns, if the UE receives a second MAC CE indicating and/or triggering the same resource set and indicating and/or triggering a second resources or second adaptation patterns, the second resources or second adaptation patterns are activated.

In some embodiments, a MAC CE de-activates N adaptation patterns in a resource set. The method to indicates and/or activates N adaptation patterns can be reused for de-activate indication. The difference is the MAC CE is used to de-activate N adaptation patterns.

In some embodiments, the resource setting includes multiple resource sets, where each resource sets are associated with different adaptation patterns.

In some embodiments, the UE only measures and reports CSIs for the indicated/activated resources or adaptation patterns.

In some embodiments, the CSI report configuration is activated and/or triggered by a DCI.

In some embodiments, the DCI indicates one or more trigger states, where each trigger state is associated with one CSI report configuration and N sub-configurations or adaptation patterns. The trigger states are indicated in a field of the DCI.

In some embodiments, if the UE receives a first DCI that triggers a CSI report configuration with a first trigger state, the UE can receive a second DCI triggering the same CSI report configuration with a second trigger state, where the sub-configurations or adaptation patterns associated with the first trigger state is different from the sub-configurations or adaptation patterns associated with the second trigger state.

In some embodiments, if the UE receives a first DCI triggering a CSI report configuration with a first trigger state, the UE does not expect to receive a second DCI triggering the same CSI report configuration with a second trigger state, wherein the sub-configurations or adaptation patterns associated with the first trigger state is same as the sub-configurations or adaptation patterns associated with the second trigger state, or the first trigger state is the same as the second trigger state.

In some embodiments, the DCI indicates a trigger state and N sub-configurations or adaptation patterns. One field in the DCI indicates a trigger state and another field in the DCI indicates N sub-configurations or adaptation patterns.

In some embodiments, the N sub-configurations or adaptation patterns are indicated in a field of the DCI. The N sub-configurations or adaptation patterns are indicated by a bitmap. Each bit in the bitmap associated with a sub-configuration or adaptation patterns. Value ‘0’ means the sub-configuration or adaptation patterns is not indicated, value ‘1’ means the sub-configuration or adaptation patterns is indicated.

In some embodiments, if the UE receives a first DCI that triggers a CSI report configuration with a first trigger state and N1 sub-configurations or adaptation patterns, the UE can receive a second DCI that triggers the same CSI report configuration with a same trigger state and N2 sub-configurations or adaptation patterns, wherein the N1 sub-configurations or adaptation patterns are different from the N2 sub-configurations or adaptation patterns.

In some embodiments, if the UE receives a first DCI that triggers a CSI report configuration with a first trigger state and N1 sub-configurations or adaptation patterns, the UE does not expect to receive a second DCI triggering the same CSI report configuration with a same trigger state and N2 sub-configurations or adaptation patterns, wherein the N1 sub-configuration or adaptation patterns are the same as the N2 sub-configurations or adaptation patterns.

In some embodiments, if a CSI report configuration is triggered by different DCIs with different sub-configurations or adaptation patterns, the UE reports the CSIs for all the sub-configurations or adaptation patterns in a same reporting occasion. In other words, the indicated and/or triggered sub-configurations or adaptation patterns are activated until the UE receives a de-activation signaling.

In some embodiments, if UE receives a first DCI triggers a CSI report configuration with a N1 sub-configurations or adaptation patterns, and UE receives a second DCI triggers the same CSI report configuration with a N2 sub-configurations or adaptation patterns after the first DCI, the CSI report configuration with a N1 sub-configurations or adaptation patterns is de-activated and the CSI report configuration with a N2 sub-configurations or adaptation patterns is activated. In another word, UE reports CSIs according to the N2 sub-configurations or adaptation patterns. (Advantageously, the gNB does not need to transmit a signaling to de-activated the CSI report configuration with N1 sub-configurations or adaptation patterns)

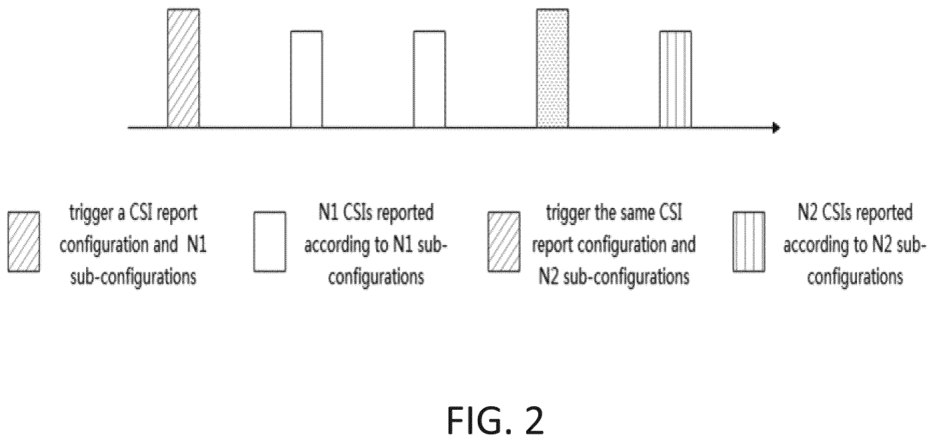

FIG. 2 illustrates an example of CSI report configuration according to an embodiment of the present invention.

In some embodiments, if a CSI report configuration is triggered by different DCIs with different sub-configurations or adaptation patterns, the UE reports the CSIs according to the sub-configurations or adaptation patterns triggered by the latest DCI.

In some embodiments, DCI triggers a CSI report configuration and N sub-configurations or adaptation patterns. The DCI also indicates time and frequency resource of a PUSCH occasion to report the N CSIs associated the N sub-configurations or adaptation patterns.

In some embodiments, the UE receives a first DCI triggering a CSI report configuration and N1 sub-configurations or adaptation patterns and a first time/frequency resource. Additionally, if the UE receives a second DCI triggering a same CSI report configuration and N2 sub-configurations or adaptation patterns and a second time/frequency resource, the UE reports N1 CSIs corresponding to N1 sub-configurations or adaptation patterns in the occasion according to first time/frequency resource and reports N2 CSIs corresponding to N2 sub-configurations or adaptation patterns in the occasion according to second time/frequency resource.

In some embodiments, the UE receives a first DCI triggering a CSI report configuration and N1 sub-configurations or adaptation patterns and a first time/frequency resource. Additionally, if the UE receives a second DCI triggering a same CSI report configuration and N2 sub-configurations or adaptation patterns and a first time/frequency resource, the UE reports N2 CSIs corresponding to N2 sub-configurations or adaptation patterns in the occasion according to first time/frequency resource. The UE does not report N1 CSIs corresponding to N1 sub-configurations or adaptation patterns in the occasion according to first time/frequency resource. In other words, N1 sub-configurations or adaptation patterns are de-activated.

In some embodiments, the UE receives a DCI triggering a CSI report configuration and/or N1 sub-configurations or adaptation patterns includes one of: UE receives a DCI, one field indicates a trigger state, the trigger state is associated with a CSI report configuration and N1 sub-configurations or adaptation patterns; UE receives a DCI, one field indicates a trigger state, the trigger state is associated with a CSI report configuration, another field indicates N1 sub-configurations or adaptation patterns.

In some embodiments, the UE receives a first DCI triggering a CSI report configuration and N1 sub-configurations or adaptation patterns and a first time/frequency resource. Additionally, if the UE receives a second DCI triggering a same CSI report configuration and N2 sub-configurations or adaptation patterns and a second time/frequency resource, the UE reports N2 CSIs corresponding to N2 sub-configurations or adaptation patterns in the occasion according to second time/frequency resource. The UE does not report N1 CSIs corresponding to N1 sub-configurations or adaptation patterns in the occasion according to the first time/frequency resource. In other words, N1 sub-configurations or adaptation patterns are de-activated.

In some embodiments, the DCI is scrambled by SP-CSI-RNTI. In some embodiments, the DCI is scrambled by C-RNTI.

In some embodiments, the DCI scrambled with SP-CSI-RNTI is used to trigger a semi-persistent CSI report and/or used to indicate and/or trigger N sub-configurations or adaptation patterns. The DCI includes one ‘CSI request’ field is used to indicate a trigger state. The trigger state associate with a CSI report configuration. Additionally, another field is used to indicate N sub-configurations configured in the CSI report.

In some embodiments, the DCI scrambled with SP-CSI-RNTI is used to trigger a semi-persistent CSI report and/or used to indicate and/or trigger N sub-configurations or adaptation patterns. The DCI includes one ‘CSI request’ field is used to indicate a trigger state. The trigger state is associated with a CSI report configuration and N sub-configurations or adaptation patterns.

In some embodiments, the DCI scrambled with C-RNTI is used to trigger an aperiodic CSI report and/or used to indicate and/or trigger N sub-configurations or adaptation patterns. The DCI includes one ‘CSI request’ field is used to indicate a trigger state. Additionally, another field is used to indicate N sub-configurations or adaptation patterns configured in the CSI report.

In some embodiments, the DCI scrambled with C-RNTI is used to trigger an aperiodic CSI report and/or used to indicate and/or trigger N sub-configurations or adaptation patterns. The DCI includes one ‘CSI request’ field used to indicate a trigger state. The trigger state is associated with a CSI report configuration and N sub-configurations or adaptation patterns.

In some embodiments, the CSI report configuration is activated and/or triggered by a MAC CE.

In some embodiments, the CSI report configuration is associated with a semi-persistent CSI-RS resource setting. The resources/or adaptation patterns in a resource set of the semi-persistent CSI-RS resource setting are triggered and/or indicated by a first MAC CE, and the CSI report configuration is activated by a second MAC CE, if the UE receives a third MAC CE triggering and/or indicating another resource/or adaptation patterns, the CSI report configuration is implicit de-activated. The UE reports CSIs according to the resources/or adaptation patterns indicated by the third MAC CE only if the UE receives a fourth MAC CE to indicate and/or trigger the CSI report configuration.

In some embodiments, the MAC CE, which triggers the CSI report configuration, also indicates N sub-configurations or adaptation patterns.

In some embodiments, for the MAC CE, S₀ refers to the report configuration which includes PUCCH resources for SP (semi-persistent) CSI reporting in the indicated BWP and has the lowest CSI-ReportConfigId within the list with type set to semiPersistentOnPUCCH, S₁ to the report configuration which includes PUCCH resources for SP CSI reporting in the indicated BWP and has the second lowest CSI-ReportConfigId and so on. The Sᵢ field is set to 1 to indicate that the corresponding Semi-Persistent CSI report configuration may be activated. The Sᵢ field is set to 0 to indicate that the corresponding Semi-Persistent CSI report configuration i may be deactivated.

Sub₀ refers to the sub-configuration or adaptation patterns which is first sub-configuration in a CSI report configuration or first adaptation pattern. Sub₁ refers to the sub-configuration or adaptation patterns which is second sub-configuration in a CSI report configuration or second adaptation pattern, as so on. The Subᵢ field is set to 1 to indicate that the corresponding sub-configuration or adaptation patterns is indicated. The Subᵢ field is set to 0 to indicate that the corresponding sub-configuration or adaptation patterns is not indicated.

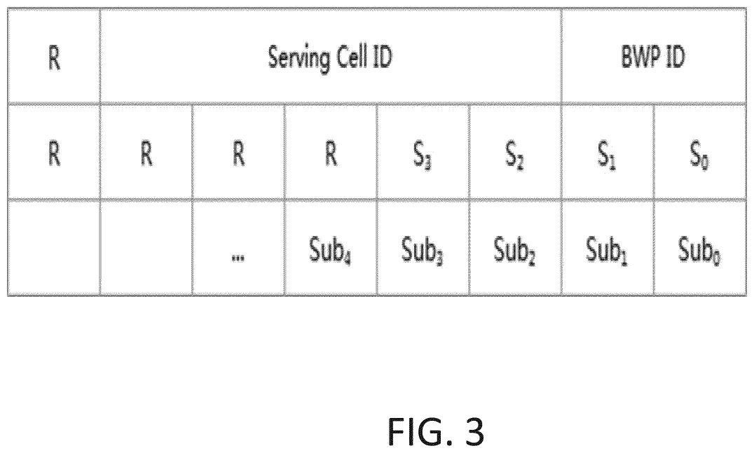

FIG. 3 illustrates a MAC CE for the semi-persistent CSI according to an embodiment of the invention.

In some embodiments, a field of DCI or a MAC CE is used to de-activate a CSI report configuration with N sub-configurations or adaptation patterns. The method of indicate and/or activate and/or trigger a CSI report configuration with N sub-configurations or adaptation patterns can be reused.

In some embodiments, the sub-configuration or adaptation patterns indication and/or activation indicated by the DCI or a MAC CE can applied to periodic CSI report, semi-persistent CSI report, and aperiodic CSI report.

In some embodiments, a first DCI is used to indicate N sub-configurations or adaptation patterns for the aperiodic CSI report. A second DCI is used to indicate N sub-configurations or adaptation patterns for the semi-persistent CSI report on the PUSCH. A MAC CE is used to indicate N sub-configurations or adaptation patterns for the semi-persistent CSI report on the PUCCH.

In some embodiments, a first DCI is used to indicate N sub-configurations or adaptation patterns for the aperiodic CSI report. A second DCI is used to indicate N sub-configurations or adaptation patterns for the semi-persistent CSI report on the PUSCH and the periodic CSI report. A MAC CE is used to indicate N sub-configurations or adaptation patterns for the semi-persistent CSI report on the PUCCH and the periodic CSI report.

In some embodiments, a first DCI is used to indicate N sub-configurations or adaptation patterns for the aperiodic CSI report and periodic CSI report. A second DCI is used to indicate N sub-configurations or adaptation patterns for the semi-persistent CSI report on the PUSCH and the periodic CSI report. A MAC CE is used to indicate N sub-configurations or adaptation patterns for the semi-persistent CSI report on the PUCCH and the periodic CSI report.

In some embodiments, a first DCI is used to indicate N sub-configurations or adaptation patterns for the aperiodic CSI. A MAC CE is used to indicate N sub-configurations or adaptation patterns for the semi-persistent CSI report on the PUCCH and the periodic CSI. A second DCI is used to indicate N sub-configurations or adaptation patterns for the semi-persistent CSI report on the PUSCH.

In some embodiments, a first DCI is used to indicate N sub-configurations or adaptation patterns for the aperiodic CSI. A MAC CE is used to indicate N sub-configurations or adaptation patterns for the semi-persistent CSI report on the PUCCH. A second DCI is used to indicate N sub-configurations or adaptation patterns for the semi-persistent CSI report on the PUSCH and the periodic CSI.

In an embodiment, a CSI report configuration is configured with K semiPersistentOnPUSCH and L sub-configurations.

Each semiPersistentOnPUSCH is associated with one or more sub-configurations. The CSIs for the one or more sub-configurations are reported according to the corresponding semiPersistentOnPUSCH.

In some embodiments, the CSIs reported according to a specific semiPersistentOnPUSCH is reported without overhead reduction.

In some embodiments, the specific semiPersistentOnPUSCH is predefined or configured by RRC signaling. For example, semiPersistentOnPUSCH is the first or with lowest index semiPersistentOnPUSCH configured in the CSI report configuration.

In some embodiments, the CSIs reported according to a specific semiPersistentOnPUSCH is reported with overhead reduction.

In some embodiments, the specific semiPersistentOnPUSCH is predefined or configured by RRC signaling. For example, semiPersistentOnPUSCH is the first or with lowest index semiPersistentOnPUSCH configured in the CSI report configuration.

In some embodiments, the periodic (configured by reportSlotConfig) configured in each semiPersistentOnPUSCH are same.

In an embodiment, a CSI report configuration is configured with K semiPersistentOnPUCCH or K periodic or K reportSlotConfig or K pucch-CSI-ResourceList and L sub-configurations.

In some embodiments, each semiPersistentOnPUCCH or each periodic includes a reportSlotConfig and a pucch-CSI-ResourceList. The reportSlotConfig indicates the periodicity.

In some embodiments, each semiPersistentOnPUCCH or periodic or reportSlotConfig or pucch-CSI-ResourceList are associated with one or more sub-configurations. The CSIs for the one or more sub-configurations are reported according to the corresponding resource.

In some embodiments, the CSIs reported according to a specific semiPersistentOnPUCCH or periodic or pucch-CSI-ResourceList is reported without overhead reduction.

In some embodiments, the specific semiPersistentOnPUCCH or periodic or pucch-CSI-ResourceList is predefined or configured by RRC signaling. For example, semiPersistentOnPUCCH or periodic or pucch-CSI-ResourceList is the first or with lowest index semiPersistentOnPUCCH or periodic or pucch-CSI-ResourceList configured in the CSI report configuration.

In some embodiments, the CSIs reported according to a specific semiPersistentOnPUCCH or periodic or pucch-CSI-ResourceList is reported with overhead reduction.

In some embodiments, the specific semiPersistentOnPUCCH or reportSlotConfig or pucch-CSI-ResourceList is predefined or configured by RRC signaling. For example, semiPersistentOnPUCCH or reportSlotConfig or pucch-CSI-ResourceList is the first or with lowest index semiPersistentOnPUCCH or reportSlotConfig or pucch-CSI-ResourceList configured in the CSI report configuration.

In some embodiments, the periodic (configured by reportSlotConfig) configured in each semiPersistentOnPUCCH or periodic are same.

In some embodiments, the PUCCH resource (configured by pucch-CSI-ResourceList) configured in each semiPersistentOnPUCCH or periodic are different.

In an embodiment, a CSI report configuration is configured with K semiPersistentOnPUSCH, semiPersistentOnPUCCH, periodic, reportSlotConfig, or pucch-CSI-ResourceList. The CSI report configuration is also configured with L sub-configurations. The DCI or the MAC CE which trigger the CSI report configuration may also indicate one or more semiPersistentOnPUSCH, semiPersistentOnPUCCH, periodic reportSlotConfig and/or pucch-CSI-ResourceList. The UE reports CSIs according to the sub-configurations associated with the indicated one or more semiPersistentOnPUSCH, semiPersistentOnPUCCH, periodic, reportSlotConfig and/or pucch-CSI-ResourceList.

### Differential CQI

### Embodiment 1

In an embodiment, the UE reports N CSIs with overhead reduction. The N CSIs with overhead reduction include at least a first differential CQI. The UE reports a first different CQI according to a codepoint.

In an embodiment, the first differential CQI indicates a Quantized offset value. The offset value indicates an offset between a first wideband CQI index and a second wideband CQI index. The quantization method is predefined or configured by high layer signaling. First wideband CQI index is a wideband CQI index for a first sub-configuration or first adaptation pattern. The second wideband CQI index is a wideband CQI index for a second sub-configuration or second adaptation pattern.

For example, the offset value=second wideband CQI index−first wideband CQI index.

TABLE 1
(Example 1)

| First differential CQI (e.g., | | |
|---|---|---|
| using codepoint) | quantized value | Offset value |
| 00 | 0 | >=0 |
| 01 | −1 | −1 |
| 10 | −2 | −2 |
| 11 | −4 | <=−3 |

TABLE 2
(Example 2)

| First differential CQI(e.g., | | |
|---|---|---|
| using codepoint) | quantized value | Offset value |
| 0 | 0 | >=0 |
| 1 | −X | <0 |

X is a value greater than 0 and less than 7 (e.g., X=1, 2, 3, or 4). In some embodiments, X is a predefined value. In some embodiments, X is configured by higher layer signaling. In some embodiments, X is different values for different sub-configurations or adaptation patterns. In some embodiments, a sub-configuration or adaptation pattern associates with a X.

In some embodiments, a reported second wideband CQI index is determined by first differential CQI and first wideband CQI index.

In some embodiments, the reported second wideband CQI index=first wideband CQI index+first differential CQI value (i.e., quantized value).

In some embodiments, a reported second subband CQI index is determined by first differential CQI and first subband CQI index.

In some embodiments, the reported second subband CQI index=first subband CQI index+first differential CQI value (i.e., quantized value).

### Embodiment 2

In some embodiments, the first differential CQI indicates an offset value. The offset value indicates an offset between a first wideband CQI index and a second wideband CQI index. The first wideband CQI index is a wideband CQI index for a first sub-configuration or first adaptation pattern. The second wideband CQI index is a wideband CQI index for a second sub-configuration or second adaptation pattern.

For example, the Offset value=second wideband CQI index−first wideband CQI index.

TABLE 3
(Example 3)

| First differential CQI (e.g., | |
|---|---|
| using codepoint) | Offset value |
| 00 | >=0 |
| 01 | −1 |
| 10 | −2 |
| 11 | <=−3 |

TABLE 4
(Example 4)

| First differential CQI (e.g., | |
|---|---|
| using codepoint) | Offset value |
| 00 | >=0 |
| 01 | X1 |
| 10 | X2 |
| 11 | <=X3 |

X1, X2, and X3 are values less than 0 and greater than −7 (e.g., X1=−1, X2=−2, X3=−3). In some embodiments, X1, X2, and X3 are predefined values. In some embodiments, X1, X2, and X3 are configured by higher layer signaling. In some embodiments, X1, X2, and X3 have different values for different sub-configurations or adaptation patterns. In some embodiments, X1, X2, and/or X3 is associated with sub-configuration or adaptation pattern. In some embodiments, a sub-configuration or adaptation pattern associates with a set of X1, X2, and X3.

TABLE 5
(Example 5)

| First differential CQI (e.g., | |
|---|---|
| using codepoint) | Offset value |
| 0 | >=0 |
| 1 | <0 |

### Embodiment 3

In some embodiments, the UE reports N CSIs with overhead reduction. The N CSIs with overhead reduction includes at least a second differential CQIs. The UE reports a second different CQI according to a codepoint.

In some embodiments, the second differential CQI indicates a Quantized offset value. The offset value indicates an offset between a wideband CQI index and a second subband CQI index. In some embodiments, the offset value indicates an offset between a first subband CQI index and a second subband CQI index. The first subband CQI index is a subband CQI index for the first sub-configuration or first adaptation pattern. The second subband CQI index is a subband CQI index for a second sub-configuration or second adaptation pattern. The wideband CQI index can be wideband CQI index for the first sub-configuration or first adaptation pattern. In some embodiments, the wideband CQI index can be wideband CQI index for the second sub-configuration or second adaptation pattern. The quantization method is predefined or configured by high layer signaling. For example,

$$\begin{matrix}Offset value ( s ) = second subband CQI index ( s ) - first wideband CQI index , or \\ Offset value ( s ) = second subband CQI index ( s ) - second wideband CQI index , or \\ Offset value ( s ) = second subband CQI index ( s ) - first subband CQI index ( s ) .\end{matrix}$$

TABLE 6
(Example 6)

| Second differential CQI | Second differential CQI | Offset |
|---|---|---|
| (e.g., using codepoint) | value (quantized value) | value |
| 0 | 0 | >=0 |
| 1 | −X | <0 |

X is a value greater than 0 and less than 7 (e.g., X=1, 2, 3, or 4). In some embodiments, X is a predefined value. In some embodiments, X is configured by higher layer signaling. In some embodiments, X may a different value for different sub-configurations or spatial patterns. In some embodiments, a sub-configuration or adaptation pattern associates with a certain X.

### Embodiment 4

In some embodiments, the UE reports N CSIs with overhead reduction. The N CSIs with overhead reduction includes at least a second differential CQIs. The UE reports a second different CQI according to a codepoint.

In some embodiments, the second differential CQI indicates an offset value, the offset value indicates an offset between a wideband CQI index and a second subband CQI index. In some embodiments, the offset value indicates an offset between a first subband CQI index and a second subband CQI index. The first subband CQI index is a subband CQI index for the first sub-configuration or first adaptation pattern. The second subband CQI index is a subband CQI index for a second sub-configuration or second adaptation pattern. The wideband CQI index can be a wideband CQI index for the first sub-configuration or first adaptation pattern. In some embodiments, the wideband CQI index can be a wideband CQI index for the second sub-configuration or second adaptation pattern. For example,

$$\begin{matrix}Offset value ( s ) = second subband CQI index ( s ) - first wideband CQI index , or \\ Offset value ( s ) = second subband CQI index ( s ) - second wideband CQI index , or \\ Offset value ( s ) = second subband CQI index ( s ) - first subband CQI index ( s ) .\end{matrix}$$

Offset value(s) means the offset value for the s^{th} subband. The subband CQI index(s) means the subband CQI index for the s^{th} subband.

TABLE 7
(Example 7)

| Second differential CQI (e.g., | |
|---|---|
| using codepoint) | Offset value |
| 00 | >−0 |
| 01 | X1 |
| 10 | X2 |
| 11 | <=X3 |

TABLE 8
(Example 8)

| Second differential CQI (e.g., | Second differential CQI (e.g., |
|---|---|
| using codepoint) | using codepoint) |
| 0 | >=0 |
| 1 | <0 |

TABLE 9
(Example 9)

| Second differential CQI (e.g., | |
|---|---|
| using codepoint) | Offset value |
| 0 | >=(0 + first offset value) |
| 1 | <(0 + first offset value) |

$$First offset value = s econd wideband CQI index - first wideband CQI index .$$

### Embodiment 5

In some embodiments, the UE reports N CSIs with overhead reduction. The N CSIs with overhead reduction includes at least a third differential CQIs.

The third differential CQIs is a mean differential CQI value.

Third differential CQI=mean (first offset value, second offset value(s)), in which mean is the mean function.

First offset value=second wideband CQI index−first wideband CQI index.

Second offset value(s)=second subband CQI index(s)−first subband CQI index(s).

In some embodiments, the first wideband CQI index is a wideband CQI index for the first sub-configuration or the first adaptation pattern. The first sub-configuration or the first adaptation pattern is predefined or indicated by higher layer signaling. For example, the first sub-configuration or the first adaptation pattern is the sub-configuration or adaptation pattern associated with the largest number of ports or the lowest group ID or the lowest CRI or the smallest powerControlOffset or the largest powerControlOffsetSS. In some embodiments, the first sub-configuration or the first adaptation pattern is as a baseline sub-configuration or adaptation pattern.

In some embodiments, the second wideband CQI index is the wideband CQI index for the second sub-configuration or second adaptation pattern. The second sub-configuration or second adaptation pattern other than the baseline sub-configuration or adaptation pattern.

In some embodiments, the first subband CQI index is the subband CQI index for the first sub-configuration or first adaptation pattern. The first sub-configuration or first adaptation pattern can be any sub-configuration or adaptation pattern.

### Differential RI

In some embodiments, the UE reports N CSIs with overhead reduction. The N CSIs with overhead reduction includes at least a common PMI and a worst layer indication (WLI). In some embodiments, the N CSIs with overhead reduction includes at least a worst layer indication (WLI).

In some embodiments, the WLI indicates which column of the precoder matrix of the common PMI corresponds to the weakest layer of the codeword.

In some embodiments, the WLI indicates which column of the precoder matrix of the reported PMI corresponds to the weakest layer of the codeword corresponding to the largest/smallest reported wideband CQI. If two wideband CQIs are reported and have equal value, the WLI corresponds to weakest layer of the first codeword.

In some embodiments, the WLI is indicated according to a codepoint in an information field. The length of the information field is based on a supported maximum rank. For example, the supported maximum rank is U, then the length of the information field is function (log 2(U)), in which function is a round up function, a round function, or a function keeping the original value. In some embodiments, the length of the information field is 2 bits. Each codepoint corresponding to one column of the precoder matrix of the common PMI. In some embodiments, the mapping between codepoint and column of the precoder matrix is predefined.

The table below illustrates an example.

| WLI (e.g., codepoint) | Column of the precoder matrix |
|---|---|
| 00 | 1^{st} column |
| 01 | 2^{nd} column |
| 10 | 3^{rd} column |
| 11 | 4^{th} column |

In some embodiments, the UE reports N CSIs with overhead reduction. The N CSIs with overhead reduction includes at least one RI, a common PMI, (N−1) differential RIs and (N−1) worst layer indications (WLIs).

In some embodiments, the differential RI indicates an offset value between a first RI and a second RI. First RI is RI value of a first sub-configuration or first adaptation pattern. The second RI is RI value of a second sub-configuration or second adaptation pattern.

In some embodiments, the differential RI=second RI−first RI.

In some embodiments, the differential RI is indicated in an information field. The length of the information field is 1 bit. In some embodiments, one state of the one bit means offset value is 0 and another state of the one bit means offset value is −1.

The table below illustrates an example.

| Differential RI | Offset value |
|---|---|
| 0 | 0 |
| 1 | −1 |

In some embodiments, the differential RI is indicated in an information field. The length of the information field is 1 bit. In some embodiments, one state of the one bit means offset value is 0 and another state of the one bit means offset value is less than or equal to −1.

The table below illustrates an example.

| Differential RI | Offset value |
|---|---|
| 0 | 0 |
| 1 | <=−1 |

In some embodiments, the differential RI is indicated in an information field. The length of the information field is 1 bit. In some embodiments, one state of the one bit means the offset value is greater than or equal to 0 and another state of the one bit means the offset value is less than or equal to −1.

The table below illustrates an example.

| Differential RI | Offset value |
|---|---|
| 0 | >=0 |
| 1 | <=−1 |

In some embodiments, one differential RI associates with one WLI. If differential RI indicates the offset value is equal to 0, the corresponding WLI is unavailable. The WLI is unavailable means the WLI will not be used or the WLI is padding bits or the WLI means no column is indicated.

In some embodiments, if differential RI indicates the offset value is not equal to 0, the WLI indicates one column of a precoder matrix.

### High Layer Configuration

Some embodiments in this section describe some high layer configuration cases.

In some embodiments, a CSI report configuration comprises L sub-configurations. Only one sub-configuration comprises a set of codebook configuration parameters. In some embodiments, the UE reports N CSIs with overhead reduction (e.g., report N PMIs) for this CSI report if the CSI report is activated.

In some embodiments, a CSI report configuration comprises L sub-configurations. Each sub-configuration includes a port subset indication or a powerOffset. In some embodiments, the UE reports N CSIs with overhead reduction for this CSI report if the CSI report is activated.

In some embodiments, a CSI report configuration comprises L sub-configurations. Each sub-configuration includes a port subset indication, a set of codebook configuration parameter(s) or a powerOffset. In some embodiments, the UE reports N CSIs without overhead reduction (e.g., report N PMIs) for this CSI report if the CSI report is activated.

In some embodiments, the set of codebook configuration parameter(s) can include at least one of the following: a codebook config, a codebook subset restriction, an RI restriction, an N1, an N2, an Ng, or a codebook type.

In some embodiments, a CSI report configuration comprises L sub-configurations. Each sub-configuration includes a group ID or a powerOffset. In some embodiments, the UE reports N CSIs with overhead reduction for this CSI report if the CSI report is activated.

In some embodiments, a CSI report configuration comprises L sub-configurations. Each sub-configuration includes a group ID, a codebook configuration parameter or a powerOffset. In some embodiments, the UE reports N CSIs without overhead reduction (e.g., report N PMIs) for this CSI report if the CSI report is activated.

In some embodiments, a CSI report configuration comprises L sub-configurations. Each sub-configuration includes at least one of a group ID, a codebook configuration parameter or a powerOffset. A CSI-RS resource setting associates with the CSI report configuration. The CSI-RS resources in the CSI-RS resource setting divided into more than one groups. Each sub-configuration is associated with one group. In some embodiments, the UE reports N CSIs without overhead reduction (e.g., report N PMIs) for this CSI report if the CSI report is activated.

In some embodiments, a CSI report configuration comprises L sub-configurations. Each sub-configuration includes a codebook configuration parameter or a powerOffset. A CSI-RS resource setting associates with the CSI report configuration. The CSI-RS resources in the CSI-RS resource setting comprise more than one number of ports. Each sub-configuration is associated with one number of ports. In some embodiments, the UE reports N CSIs without overhead reduction (e.g., report N PMIs) for this CSI report if the CSI report is activated.

In some embodiments, a CSI report configuration comprises a baseline sub-configuration or adaptation pattern indication. The baseline sub-configuration or adaptation pattern indication indicates the PMI for which the sub-configuration or adaptation pattern should be reported. In some embodiments, the sub-configuration or adaptation pattern with the lowest index or the first sub-configuration or adaptation pattern configured in the CSI report configuration is the baseline sub-configuration or adaptation pattern. In some embodiments, the baseline sub-configuration or adaptation pattern is predefined. In some embodiments, the baseline sub-configuration or adaptation pattern is configured or indicated by the gNB. In some embodiments, the baseline sub-configuration or adaptation pattern is configured or indicated by RRC signaling.

In some embodiments, a CSI report configuration comprise no sub-configuration and is associated with a CSI-RS resource setting. Each CSI-RS resource in the CSI-RS resource setting configured with more than one powerOffset or powerOffsetSS. In this case, the sub-configuration corresponds to the powerOffset or powerOffsetSS configured in the CSI-RS resource.

In some embodiments, if a CSI report configuration associated with a CSI-RS resource setting. Each CSI-RS resource in the CSI-RS resource setting configured with more than one powerOffset or powerOffsetSS. In some embodiments, the UE reports N CSIs with overhead reduction.

In some embodiments, for a CSI report configuration associated with L sub-configurations or L adaptation patterns, and UE uses reports N CSIs according to N sub-configurations or L adaptation patterns among the L sub-configurations or L adaptation patterns, the number of CPUs occupied by the CSI report configuration (OCPU) is at least one of the following: A1, number of resources for a i^{th} sub-configuration or a i^{th} adaptation pattern (Bi), a scaling factor (f), N. A1 is number of resources for a first sub-configuration or a first adaptation pattern, or A1 is number of resources for a baseline sub-configuration or a baseline adaptation pattern (A1).

For example,

$$O C P U = {\sum }_{j = 1}^{N} {B}_{v ( j )} ,$$

v(j) is the number of resources for sub-configuration or a adaptation pattern associated with the j^{th} CSI report which needs to be reported.

For example,

$$OCPU = A 1 + f \cdot {\sum }_{j = 2}^{N} {B}_{v ( j )} or OCPU = A 1 + f \cdot {\sum }_{j = 1}^{N - 1} {B}_{v ( j )} ,$$

v(j) is the number of resources for sub-configuration or a adaptation pattern associated with the j^{th} CSI report which needs to be reported.

For example, OCPU is equal to add the A1 and a reduced value. The reduced value is equal to a scaling factor multiplied by the number of all resource of sub-configuration (or adaptation pattern) other than baseline sub-configuration (or adaptation pattern) which are associated with N CSIs.

For example, OCPU=A1+N−1.

In some embodiments, if the UE is configured to report N>1 CSIs with CQI index or differential CQI, the UE may assume at least one the following for the purpose of deriving the CQI index or differential CQI, in a CSI reference resource, and if also configured, for deriving PMI and RI:
One or more corresponding ratios of PDSCH EPRE to CSI-RS EPRE, if more than one ratios of PDSCH EPRE to CSI-RS EPRE are associated with the N CSIs, each ratio of PDSCH EPRE to CSI-RS ERPE associates with one CSI (e.g., CQI, PMI, RI);
One or more corresponding sub-configurations or adaptation patterns, if more than one sub-configurations or more than one adaptation patterns are associated with the N CSIs, each sub-configurations or adaptation patterns associates with one CSI (e.g., CQI, PMI, RI);
For CQI calculation, the UE may further assume that PDSCH signals on antenna ports in the set [1000, . . . , 1000+v−1] for v layers would result in signals equivalent to corresponding symbols transmitted on N antenna ports for the N CSIs. Each antenna port is associated with a CSI. An antenna ports is associated with the active ports associated with a CSI or a corresponding sub-configurations;
For each CQI calculation among the N CSIs, the UE may further assume that PDSCH signals on antenna ports in the set [1000, . . . , 1000+v−1] for v layers would result in signals equivalent to corresponding symbols transmitted on antenna ports [3000+P(1), . . . , 3000+P(n(k))] for k^{th} CSI among the N CSIs, wherein n(k) is the number of ports associated with the k^{th} CSI, P(n(k)) is the n(k)th valid/or active port index associated with the i^{th} CSI. as given by

$$[ \begin{matrix}{y}^{3000 + P ( 1 )} ( i ) \\ … \\ {y}^{3000 + P ( n ( k ) )} ( i )\end{matrix} ] = W ( i ) [ \begin{matrix}{x}^{( 0 )} ( i ) \\ … \\ {x}^{( v - 1 )} ( i )\end{matrix} ] ;$$

W(i) is the precoding matrix determined by a common PMI or a PMI for one CSI among the N CSIs. In some embodiments, W(i) is the precoding matrix determined by a common PMI and is associated with a sub-configuration. In some embodiments, W(i) is the precoding matrix according to a PMI associated with a sub-configuration or adaptation pattern; and/or

The UE may assume that the corresponding PDSCH signals transmitted on one antenna ports have a ratio of EPRE to CSI-RS EPRE equal to the ratio configured associates with the CSI or corresponding sub-configuration or adaptation pattern.

In another word, if the UE is configured to report N>1 CSIs with CQI index or differential CQI, and if also configured, for deriving PMI and RI, the UE may assume N corresponding sub-configurations or N corresponding adaptation patterns for the purpose of deriving the CQI index or differential CQI for N CSIs, in a CSI reference resource. Each CSI among the N CSIs is calculated with a corresponding sub-configuration or adaptation pattern.

In the paragraphs below, details will be described along with some examples, but the present disclosure is not limited to the example below.

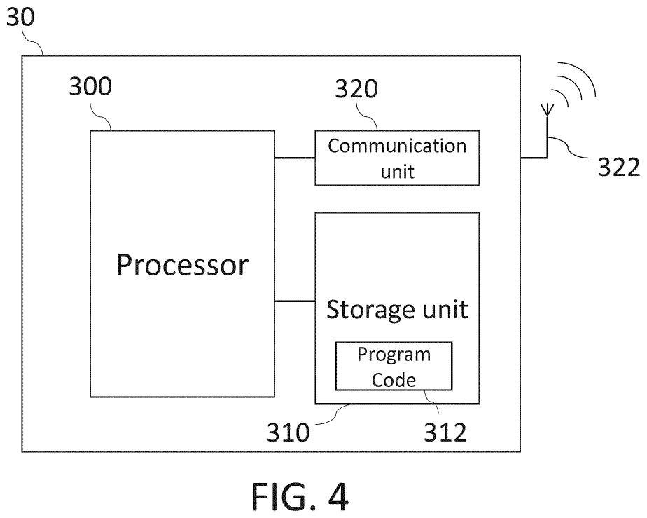

FIG. 4 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may be used to implement the UE described in this disclosure. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described in this disclosure. In some embodiments, the processor 300 and the communication unit 320 collaboratively perform the operations described in this disclosure. For example, the processor 300 performs operations and transmit or receive signals, message, and/or information through the communication unit 320.

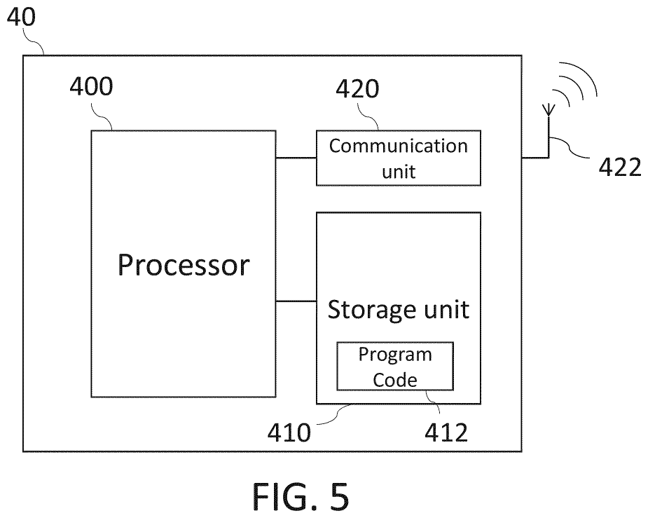

FIG. 5 relates to a diagram of a wireless communication node 40 according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may be used to implement the gNB described in this disclosure. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the gNB described in this disclosure. In some embodiments, the processor 400 and the communication unit 420 collaboratively perform the operations described in this disclosure. For example, the processor 400 performs operations and transmit or receive signals through the communication unit 420.

A wireless communication method is also provided according to an embodiment of the present disclosure. In an embodiment, the wireless communication method may be performed by using a wireless communication terminal (e.g., a UE). In an embodiment, the wireless communication terminal may be implemented by using the wireless communication terminal 30 described in this disclosure, but is not limited thereto.

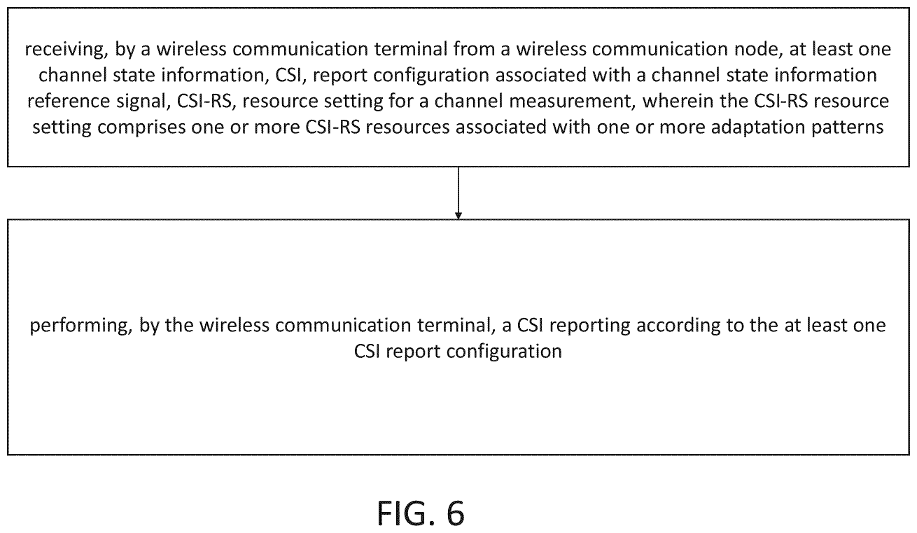

Referring to FIG. 6, in an embodiment, the wireless communication method includes: receiving, by a wireless communication terminal from a wireless communication node, at least one channel state information, CSI, report configuration associated with a channel state information reference signal, CSI-RS, resource setting for a channel measurement, wherein the CSI-RS resource setting comprises one or more CSI-RS resources associated with one or more adaptation patterns; and performing, by the wireless communication terminal, a CSI reporting according to the at least one CSI report configuration.

Details in this regard can be ascertained with reference to the paragraphs above, and will not be repeated herein.

Another wireless communication method is also provided according to an embodiment of the present disclosure. In an embodiment, the wireless communication method may be performed by using a wireless communication node (e.g., a gNB). In an embodiment, the wireless communication node may be implemented by using the wireless communication node 40 described in this disclosure, but is not limited thereto.

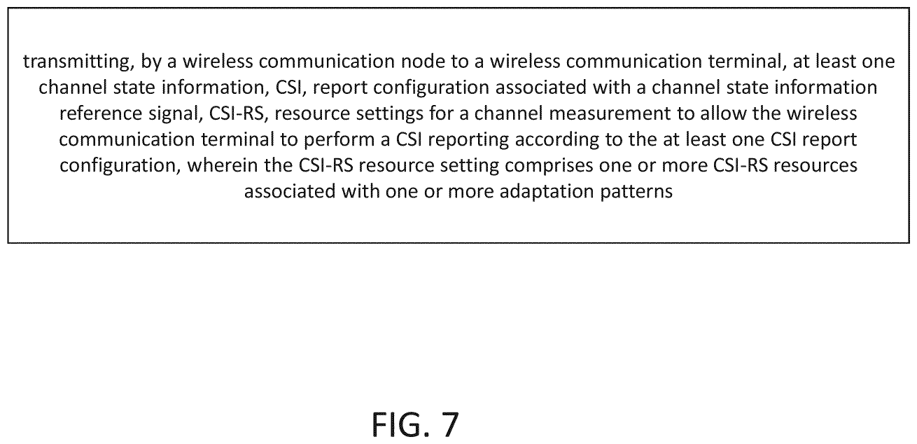

Referring to FIG. 7, in an embodiment, the wireless communication method includes transmitting, by a wireless communication node to a wireless communication terminal, at least one channel state information, CSI, report configuration associated with a channel state information reference signal, CSI-RS, resource settings for a channel measurement to allow the wireless communication terminal to perform a CSI reporting according to the at least one CSI report configuration, wherein the CSI-RS resource setting comprises one or more CSI-RS resources associated with one or more adaptation patterns.

Details in this regard can be ascertained with reference to the paragraphs above, and will not be repeated herein.

In some embodiments, the relay wireless communication terminal used in the present disclosure may indicate the UE described above.

In some embodiments, the wireless communication node used in the present disclosure may indicate the gNB described above.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

What is claimed is:

1. A wireless communication method for use in a wireless terminal, comprising:
receiving, from a wireless communication node, at least one channel state information (CSI) report configuration associated with a channel state information reference signal (CSI-RS) resource setting for a channel measurement, wherein the CSI-RS resource setting comprises one or more CSI-RS resources associated with one or more sub-configurations;
receiving an indication activating a CSI report configuration and a part of sub-configurations among all sub-configurations associated with the CSI report configuration to be activated; and
performing a CSI reporting according to the at least one CSI report configuration.

2. The wireless communication method of claim 1, wherein the CSI report configuration is activated by a MAC CE, wherein the MAC CE, which activated the CSI report configuration, also activated N sub-configurations.

3. The wireless communication method of claim 2, wherein for the MAC CE, S₀ refers to the report configuration which includes PUCCH resources for semi-persistent (SP) CSI reporting in an indicated BWP and has the lowest CSI-ReportConfigId within the list with type set to semiPersistentOnPUCCH, S₁ refers to the report configuration which includes PUCCH resources for SP CSI reporting in the indicated BWP and has the second lowest CSI-ReportConfigId and so on, wherein when the Sᵢ field is set to 1 it indicates that the corresponding Semi-Persistent CSI report configuration may be activated and when the Sᵢ field is set to 0 it indicates that the corresponding Semi-Persistent CSI report configuration i may be deactivated;
Sub₀ refers to the sub-configuration which is first sub-configuration in a CSI report configuration, Sub₁ refers to the sub-configuration which is second sub-configuration in a CSI report configuration and so on, wherein when the Subᵢ field is set to 1 it indicates that the corresponding sub-configuration is activated and when the Subᵢ field is set to 0 it indicates that the corresponding sub-configuration is not activated.

4. The wireless communication method of claim 1, wherein the CSI report configuration is activated by a downlink control information (DCI), wherein the DCI scrambled with SP-CSI-RNTI is used to trigger N sub-configurations.

5. The wireless communication method of claim 4, wherein the DCI includes one ‘CSI request’ field used to indicate one or more trigger states, wherein a trigger state is associated with a CSI report configuration and the N sub-configurations.

6. The wireless communication method of claim 1, wherein the wireless communication terminal reports to the wireless communication node CSIs without overhead reduction in response to a first condition being satisfied, and the first condition comprises at least one of:
a CSI report configuration corresponding to the CSIs indicating that the CSI reporting is aperiodic; or
a CSI report configuration corresponding to the CSIs being activated or triggered by Downlink Control Information (DCI).

7. The wireless communication method of claim 1, wherein a CSI report configuration comprises L sub-configurations associated with K uplink resource configurations, L and K are integers, each uplink resource configuration correspond to one or more of the L sub-configurations, and one or more CSIs corresponding to one or more sub-configurations among the L sub-configurations associated with a corresponding uplink resource configuration are reported according to the corresponding uplink resource configuration.

8. The wireless communication method of claim 3, wherein each uplink resource configuration is at least one of:
a configuration semiPersistentOnPUSCH;
a configuration semiPersistentOnPUCCH; or
a configuration periodic.

9. The wireless communication method of claim 1, wherein after the wireless communication terminal receives:
a first signaling with a first field indicating a first trigger state for activating a CSI report configuration and a second field activating a first part of sub-configurations among all sub-configurations or a first part of adaptation patterns among all adaptation patterns associated with the CSI report configuration to be activated, the wireless communication terminal is able to receive a second signaling with a first field indicating a second trigger state for activating the CSI report configuration and a second field activating a second part of sub-configurations among all sub-configurations or a second part of adaptation patterns among all adaptation patterns associated with the CSI report configuration to be activated, wherein the first part of sub-configurations and the second part of sub-configurations are different, or the first part of adaptation patterns and the second part of adaptation patterns are different; or
an indication of a first signaling for activating a CSI report configuration and activating a first part of sub-configurations among all sub-configurations or a first part of adaptation patterns among all adaptation patterns associated with the CSI report configuration to be activated, the wireless communication terminal is able to receive an indication of a second signaling for activating the CSI report configuration and activating a second part of sub-configurations among all sub-configurations or a second part of adaptation patterns among all adaptation patterns associated with the CSI report configuration to be activated, wherein the first trigger state indicated in a field of first signaling indicates the CSI report configuration to be activated and the first part of the sub-configurations or the first part of adaptation patterns, the second trigger state indicated in a field of second signaling indicates the CSI report configuration to be activated and the second part of the sub-configurations or the second part of adaptation patterns, and the first part of sub-configurations and the second part of sub-configurations are different, or the first part of adaptation patterns and the second part of adaptation patterns are different,
wherein the first signaling or second signaling is a Downlink Control Information (DCI) or a Medium Access Control Control Element (MAC CE),
wherein a bitmap is used to activate a part of sub-configurations among all sub-configurations associated with the CSI report configuration to be activated, wherein:
each bit in the bitmap is associated with one or more sub-configurations,
a first value of a bit indicates one or more corresponding sub-configurations are not activated or deactivated, and
a second value different from the first value of a bit indicates one or more corresponding sub-configurations are activated.

10. A wireless communication method for use in a wireless communication node comprising:
transmitting, to a wireless communication terminal, at least one channel state information (CSI) report configuration associated with a channel state information reference signal (CSI-RS) resource settings for a channel measurement to allow the wireless communication terminal to perform a CSI reporting according to the at least one CSI report configuration, wherein the CSI-RS resource setting comprises one or more CSI-RS resources associated with one or more sub-configurations; and
transmitting an indication activating a CSI report configuration and a part of sub-configurations among all sub-configurations associated with the CSI report configuration to be activated.

11. The wireless communication method of claim 10, wherein the CSI report configuration is activated by a MAC CE, wherein the MAC CE, which activated the CSI report configuration, also activated N sub-configurations.

12. The wireless communication method of claim 11, wherein for the MAC CE, S₀ refers to the report configuration which includes PUCCH resources for semi-persistent (SP) CSI reporting in a indicated BWP and has the lowest CSI-ReportConfigId within the list with type set to semiPersistentOnPUCCH, S₁ refers to the report configuration which includes PUCCH resources for SP CSI reporting in the indicated BWP and has the second lowest CSI-ReportConfigId and so on, wherein when the Sᵢ field is set to 1 it indicates that the corresponding Semi-Persistent CSI report configuration may be activated and when the Sᵢ field is set to 0 it indicates that the corresponding Semi-Persistent CSI report configuration i may be deactivated;
Sub₀ refers to the sub-configuration which is first sub-configuration in a CSI report configuration, Sub₁ refers to the sub-configuration which is second sub-configuration in a CSI report configuration and so on, wherein when the Subᵢ field is set to 1 it indicates that the corresponding sub-configuration is activated and when the Subᵢ field is set to 0 it indicates that the corresponding sub-configuration is not activated.

13. The wireless communication method of claim 10, wherein the CSI report configuration is activated by a downlink control information (DCI), wherein the DCI scrambled with SP-CSI-RNTI is used to trigger N sub-configurations.

14. The wireless communication method of claim 13, wherein the DCI includes one ‘CSI request’ field used to indicate one or more trigger states, wherein a trigger state is associated with a CSI report configuration and the N sub-configurations.

15. The wireless communication method of claim 10, wherein the wireless communication node receives a report from the wireless communication node CSIs without overhead reduction in response to a first condition being satisfied, and the first condition comprises at least one of:
a CSI report configuration corresponding to the CSIs indicating that the CSI reporting is aperiodic; or
a CSI report configuration corresponding to the CSIs being activated or triggered by Downlink Control Information (DCI).

16. The wireless communication method of claim 10, wherein a CSI report configuration comprises L sub-configurations associated with K uplink resource configurations, L and K are integers, each uplink resource configuration correspond to one or more of the L sub-configurations, and one or more CSIs corresponding to one or more sub-configurations among the L sub-configurations associated with a corresponding uplink resource configuration are reported according to the corresponding uplink resource configuration.

17. The wireless communication method of claim 16, wherein each uplink resource configuration is at least one of:
a configuration semiPersistentOnPUSCH;
a configuration semiPersistentOnPUCCH; or
a configuration periodic.

18. The wireless communication method of claim 10, wherein a first signaling or second signaling is a Downlink Control Information (DCI) or a Medium Access Control Control Element (MAC CE), a bitmap is used to activate a part of sub-configurations among all sub-configurations or a part of adaptation patterns among all adaptation patterns associated with the CSI report configuration to be activated, each bit in the bitmap is associated with one or more sub-configurations or one or more adaptation patterns, a first value of a bit indicates one or more corresponding sub-configurations or one or more adaptation patterns are not activated or deactivated, and a second value different from the first value of a bit indicates one or more corresponding sub-configurations or one or more adaptation patterns are activated.

19. A wireless communication terminal, comprising:
a communication unit; and
at least one processor configured to:
receive, via the communication unit from a wireless communication node, at least one channel state information (CSI) report configuration associated with a channel state information reference signal (CSI-RS) resource setting for a channel measurement, wherein the CSI-RS resource setting comprises one or more CSI-RS resources associated with one or more sub-configurations;
receive an indication activating a CSI report configuration and a part of sub-configurations among all sub-configurations associated with the CSI report configuration to be activated; and
perform a CSI reporting according to the at least one CSI report configuration.

20. A wireless communication node, comprising:
a communication unit; and
at least one processor configured to:
transmit, to a wireless communication terminal, at least one channel state information (CSI) report configuration associated with a channel state information reference signal (CSI-RS) resource settings for a channel measurement to allow the wireless communication terminal to perform a CSI reporting according to the at least one CSI report configuration, wherein the CSI-RS resource setting comprises one or more CSI-RS resources associated with one or more sub-configurations; and
transmit an indication activating a CSI report configuration and a part of sub-configurations among all sub-configurations associated with the CSI report configuration to be activated.
